(19) United States
(12) Patent Application Publication
(10) Pub. No.: US 2025/0190327 A1
(43) Pub. Date: Jun. 12, 2025

(54) DYNAMIC CTD MODEL TRACKING AND OPTIMIZATION

(71) Applicant: INTERNATIONAL BUSINESS MACHINES CORPORATION, ARMONK, NY (US)

(72) Inventors: ANDREW C. M. HICKS, HIGHLAND, NY (US); DEBORAH A. FURMAN, STAATSBURG, NY (US); RYAN THOMAS RAWLINS, NEW PALTZ, NY (US); MICHAEL E GILDEIN, WAPPINGERS FALLS, NY (US)

(21) Appl. No.: 18/531,910

(22) Filed: Dec. 7, 2023

(51) Int. Cl. G06F 11/36

(52) U.S. Cl. CPC G06F 11/3608; G06F 11/3676; G06F 11/368; G06F 11/3698

(57) ABSTRACT

Dynamic CTD model tracking and optimization, including: identifying a difference in coverage between a CTD model and a dynamically generated CTD model generated by applying one or more test environment limitations to the CTD model; and maintaining a listing of uncovered value combinations.

### BACKGROUND

The present disclosure relates to methods, apparatus, and products for dynamic combinatorial test design (CTD) model tracking and optimization.

### SUMMARY

According to embodiments of the present disclosure, various methods, apparatus and products for dynamic CTD model tracking and optimization are described herein. In some aspects, dynamic CTD model tracking and optimization includes identifying a difference in coverage between a CTD model and a dynamically generated CTD model generated by applying one or more test environment limitations to the CTD model; and maintaining a listing of uncovered value combinations. In some aspects, an apparatus may include a processing device; and memory operatively coupled to the processing device, wherein the memory stores computer program instructions that, when executed, cause the processing device to perform this method. In some aspects, a computer program product comprising a computer readable storage medium may store computer program instructions that, when executed, perform this method.

### BRIEF DESCRIPTION OF THE DRAWINGS

FIG. 1 sets forth an example computing environment for dynamic CTD model tracking and optimization in accordance with some embodiments of the present disclosure.

FIG. 2 sets forth a flowchart of an example method for dynamic CTD model tracking and optimization in accordance with some embodiments of the present disclosure.

FIG. 3 sets forth a flowchart of another example method for dynamic CTD model tracking and optimization in accordance with some embodiments of the present disclosure.

FIG. 4 sets forth a flowchart of another example method for dynamic CTD model tracking and optimization in accordance with some embodiments of the present disclosure.

FIG. 5 sets forth a flowchart of another example method for dynamic CTD model tracking and optimization in accordance with some embodiments of the present disclosure.

FIG. 6 sets forth a flowchart of another example method for dynamic CTD model tracking and optimization in accordance with some embodiments of the present disclosure.

### DETAILED DESCRIPTION

Combinatorial test design (CTD) models may be used in system testing to ensure optimal coverage of test cases across multiple variables or values defining your test space. Each test case scenario may be defined or expressed using multiple attributes, with each attribute being defined by a particular value from a selection of predefined values. As an example, for test case scenarios across different computing systems, a first attribute may include an operating system which may be defined by a value selected from “Windows,” “MacOS,” and “Linux.” A second attribute may include a number of processors defined by a value selected from “One,” “Two,” “Four,” and “Eight.” A third attribute may include an amount of memory, which may be defined by a value selected from “64 GB,” “128 GB,” “256 GB,” and “512 GB.” A fourth attribute may include the presence of a graphics card which may be defined by a value selected from “Yes” and “No.” Using this example, there would be 3×4×4×2=96 different combinations of test values. This reflects the cartesian product of all possible values for all attributes.

As the number of attributes and possible values for those attributes grows, the number of possible combinations of test values may rapidly increase to the point where it would be resource prohibitive to test each of these combinations. Using CTD models, the test space (e.g., the number of combinations tested) may be reduced by performing an n-wise reduction of the test space. An n-wise reduction is a set of test cases (e.g., a set of test value combinations) that ensures that each possible combination of n attributes is reflected in the n-wise reduction. Put differently, any set of values for n attributes will be found in the n-wise reduction. As an example, a pair-wise or two-wise reduction is a set of test cases where each possible combination of values for two attributes is reflected in the pair-wise reduction. Continuing with the example above, a pair-wise reduction would include test cases reflecting each possible combination of values for operating system and number of processors, for operating system and amount of memory, for operating system and a presence of a graphics card, for number of processors and amount of memory, etc. As another example, a three-wise reduction would include a set of test cases where each combination of values for three attributes is reflected in the three-wise reduction. This reduces the overall number of test cases required while maintaining coverage across different combinations of attribute values.

Some test environments may lack the necessary components (e.g., hardware, software, and the like) to implement particular test cases. Continuing with the example above, a test environment of multiple systems may lack any machines having 512 GB of memory or may lack systems having eight processors. Rather than have these test cases fail, a CTD model may be dynamically generated based on the CTD-model of the n-wise reduction to exclude those test cases (e.g., those combinations of attribute-value pairs) that cannot be performed due to limitations of the test environment. For example, a dynamically generated CTD model may exclude any test cases requiring 512 GB of memory or eight processors, using the example above. This may be performed by pruning the CTD model and removing those test cases with those particular values, or by reducing the space (e.g., the set of possible values) for memory or processors to exclude those values before performing an n-wise reduction. Though this prevents test cases from failing where they cannot be performed due to the limitations of the test environment, the gaps in the overall test space still persist. Accordingly, it would be beneficial to track and monitor which areas of the test space have been accounted for during testing, particularly as dynamically updated CTD models may change over time due to changes in the capabilities of the test environment.

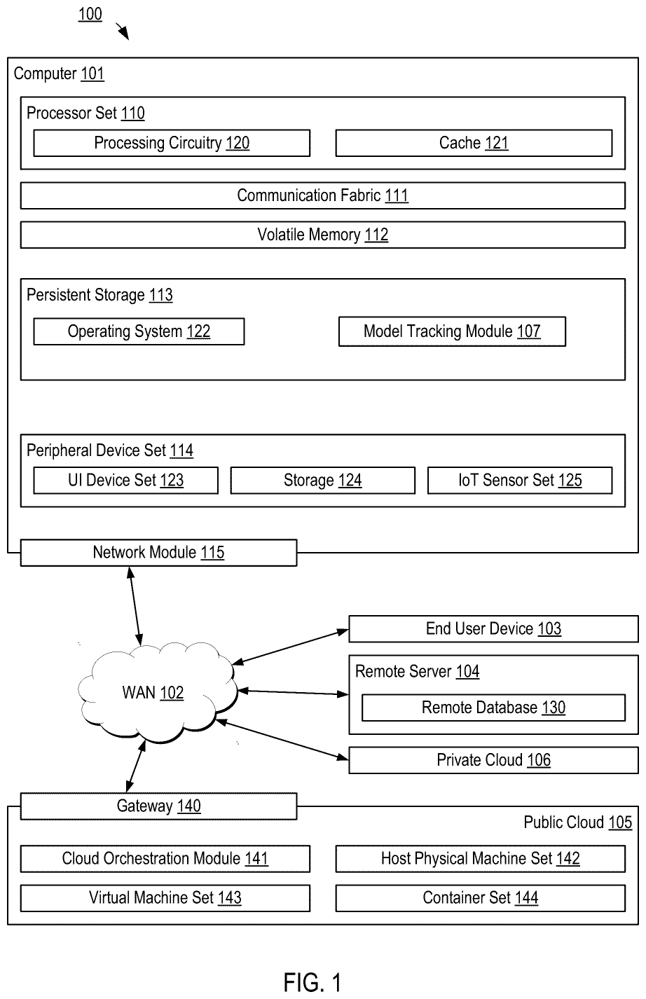

With reference now to FIG. 1, shown is an example computing environment according to aspects of the present disclosure. Computing environment 100 contains an example of an environment for the execution of at least some of the computer code involved in performing the various methods described herein, such as model tracking module 107. In addition to block 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in block 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

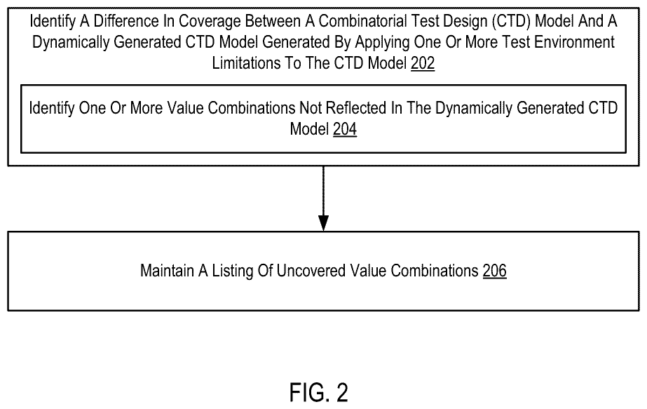

For further explanation, FIG. 2 sets forth a flowchart of an example method of dynamic CTD model tracking and optimization in accordance with some embodiments of the present disclosure. The method of FIG. 2 may be performed, for example, by the model tracking module 107 of FIG. 1. For example, the model tracking module 107 may accept, as input, data describing a CTD model, a dynamically generated CTD model generated based on various test environment limitations, and the like.

The method of FIG. 2 includes identifying 202 a difference in coverage between a CTD model and a dynamically generated CTD model generated by applying one or more test environment limitations to the CTD model. As is set forth above, a CTD model may be generated for a test space having multiple attributes with each attribute being definable using a value from a particular set of values for that attribute (e.g., a value space for that attribute). Each entry in a cartesian product for the test space would include a defined value for each attribute, with the cartesian product including each possible combination of values across all attributes. The CTD model may then be generated as an n-wise reduction of the cartesian product, with n being less than the total number of attributes. The CTD model would then include entries reflecting each possible combination of values for any n attributes. For example, a pair-wise or two-wise reduction would include each possible combination of values for any two attributes. Thus, assuming eight attributes and a pair-wise reduction, the CTD model would include multiple test cases each having values for the eight attributes such that any combination of values for any two attributes would be included in the CTD model.

As is also set forth above, a dynamically generated CTD model may be generated based on one or more limitations of the test environment. A limitation of the test environment is a particular value for a particular attribute that cannot be tested due to the configuration or available resources of the test environment, such as the configuration of computing systems in the test environment. For example, where an attribute for an amount of memory includes a possible value of 512 GB, a limitation of the test environment may include no system in the test environment having 512 GB of RAM. As another example, where an attribute for inclusion of an I/O card includes values of “Yes” and “No,” a limitation of the test environment may include no system in the test environment having an I/O card. The dynamically generated CTD model may be generated to exclude test cases (e.g., combinations of values) that cannot be executed by virtue of the limitations of the test environment. In some embodiments, the dynamically generated CTD model may be generated by removing or pruning entries from the CTD model that include particular attributes that cannot be tested due to the limitations of the test environment. In some embodiments, the dynamically generated CTD model may be generated by removing the particular values that cannot be texted from the value space of the corresponding attribute before generating, as the dynamically generated CTD model, a CTD model using this reduced test space.

The coverage of the dynamically generated CTD model includes those combinations values of n attributes (e.g., those pairs of values for a pair-wise reduction) reflected in the test cases of the dynamically generated CTD model. As the dynamically generated CTD model is generated using or otherwise reflects a reduced test space relative to the CTD model, the dynamically generated CTD model will necessarily fail to reflect some combinations of values otherwise reflected in the CTD model. Accordingly, identifying 202 a difference in coverage between the CTD model and a dynamically generated CTD model generated by applying one or more test environment limitations to the CTD model includes identifying 204 one or more value combinations not reflected in the dynamically generated CTD model. As an example, assume a CTD model generated as a pair-wise reduction of a test space including eight attributes. Further assume that a particular value for a particular attribute cannot be tested. This may result in any pair of values including that particular value and any other value for any other attribute not being reflected in the dynamically generated CTD model.

The method of FIG. 2 also includes maintaining 206 a listing of uncovered value combinations. One skilled in the art will appreciate that the tests of the dynamically generated CTD model may be performed in the test environment at any point after creation of the dynamically generated CTD model, including before, after, or concurrent to identifying 202 the difference and maintaining 206 the listing of uncovered value combinations. The listing of uncovered value combinations includes a listing of those combinations of values (e.g., those pairs of values for a pair-wise reduction) not yet tested due to not being covered in a dynamically generated CTD model.

In some embodiments, maintaining 206 a listing of uncovered value combinations includes generating the listing of uncovered value combinations to include those identified 204 value combinations not reflected in the dynamically generated CTD model. In some embodiments, maintaining 206 a listing of uncovered value combinations includes updating the listing of uncovered value combinations to exclude any listed combination of values not reflected in the dynamically generated CTD model. Thus, as the dynamically generated CTD model is updated over time due to changes in the test environment, the listing of uncovered value combinations may be updated accordingly.

The maintained listing of uncovered value combinations of the CTD model may be used to update the text environment to address particular test cases or combinations of attribute values that have yet to be tested. The maintained listing of uncovered value combinations may also be used to evaluate a degree to determine if particularly important test cases or combinations of attribute values have been addressed.

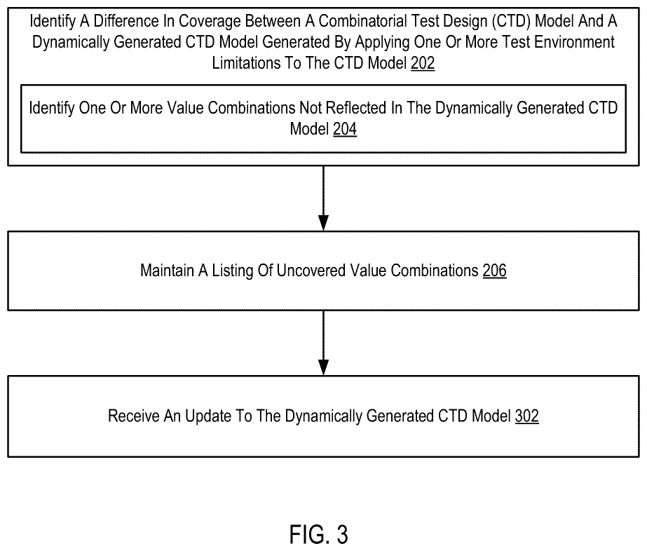

For further explanation, FIG. 3 sets forth a flowchart of another example method of dynamic CTD model tracking and optimization in accordance with some embodiments of the present disclosure. The method of FIG. 3 is similar to FIG. 2 in that the method of FIG. 3 also includes: identifying 202 a difference in coverage between a CTD model and a dynamically generated CTD model generated by applying one or more test environment limitations to the CTD model, including: identifying 204 one or more value combinations not reflected in the dynamically generated CTD model; and maintaining 206 a listing of uncovered value combinations.

The method of FIG. 3 differs from FIG. 2 in that the method of FIG. 3 also includes receiving 302 an update to the dynamically generated CTD model. In some embodiments, the update to the dynamically generated CTD model may describe an updated state of the test environment, including changes to the hardware and/or software configurations of the systems of the test environment. Thus, the updated state of the test environment may reflect an update to the one or more test environment limitations used to generate the dynamically generated CTD model. For example, an update to the state of the test environment may remedy a previous test environment limitation or introduce a new test environment limitation due to the updated configuration of the test environment.

Accordingly, in some embodiments, receiving 302 the update to the dynamically generated CTD model may cause the dynamically generated CTD model to be regenerated using the updated test environment limitations. Combinations of values reflected in the updated dynamically generated CTD model may include combinations of values not reflected in the previous version of the dynamically generated CTD model. Accordingly, test cases from the updated dynamically generated CTD model may then be executed to test these previously uncovered value combinations. In some embodiments, the listing of uncovered value combinations may be updated based on the value combinations reflected in the updated dynamically generated CTD model. For example, in some embodiments, value combinations may be removed from the listing of uncovered value combinations if reflected in the test cases of the updated dynamically generated CTD model.

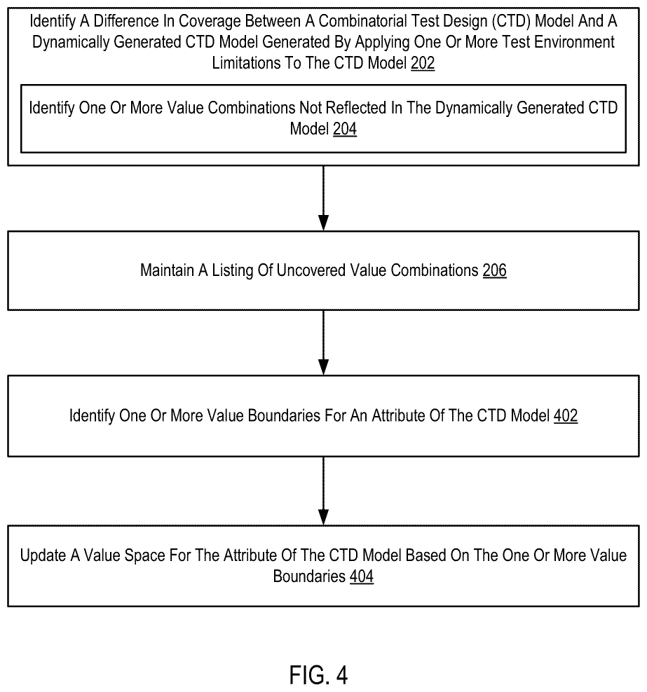

For further explanation, FIG. 4 sets forth a flowchart of another example method of dynamic CTD model tracking and optimization in accordance with some embodiments of the present disclosure. The method of FIG. 4 is similar to FIG. 2 in that the method of FIG. 4 also includes: identifying 202 a difference in coverage between a CTD model and a dynamically generated CTD model generated by applying one or more test environment limitations to the CTD model, including: identifying 204 one or more value combinations not reflected in the dynamically generated CTD model; and maintaining 206 a listing of uncovered value combinations.

The method of FIG. 4 differs from FIG. 2 in that the method of FIG. 4 also includes identifying 402 one or more value boundaries for an attribute of the CTD model. A value boundary is a minimum or maximum value in a range of values for particular attribute based on a particular configuration for a system in the test environment. Readers will appreciate that this range of values reflects the possible values for that attribute in the system of the test environment, which may not necessarily correspond to the particular value space for that attribute in the test space. Put differently, the range of values reflects a range of values that may be tested for that given configuration but does not define the particular values to be included in the test space for that attribute.

The range of values for an attribute with a given configuration may be used, for example, in identifying test environment limitations for the purpose of generating a dynamically generated CTD model. As an example, assume an attribute for a number of I/O channels with a set of possible values of “one” and “eight.” Further assume that the systems of the test environment have two I/O cards, enabling between one and four channels. Here, the range of values for that configuration of two cards is between one and four. Accordingly, one and four may be identified as boundary values for this attribute. A dynamically generated CTD model may be generated to exclude test cases having a value of “eight” as that is impossible under the given system configuration.

In some embodiments, identifying 402 the one or more value boundaries may be performed repeatedly for a multiple configurations. As an example, the value range of I/O channels for systems with two cards may be between one and four while the value range of I/O channels for systems with four cards may be between one and eight. Here, one and four would serve as value boundaries for the former configuration while one and eight would serve as value boundaries for the latter configuration.

The method of FIG. 4 also includes updating 404 a value space for the attribute of the CTD model based on the one or more value boundaries. For example, in some embodiments, the value space for a particular attribute (e.g., the particular set of values to be tested for that attribute) may be updated to include a value boundary. Continuing with the example above, the value space for a number of I/O channels may be updated to include “four” in addition to the previously included “one” and “eight.” As another example, in some embodiments, the value space for a particular attribute may be updated to include a value incrementally higher or lower than a value boundary. Continuing with the example above, the value space for a number of I/O channels may be updated to include “five” as it is incrementally one greater than the value boundary of “four.”

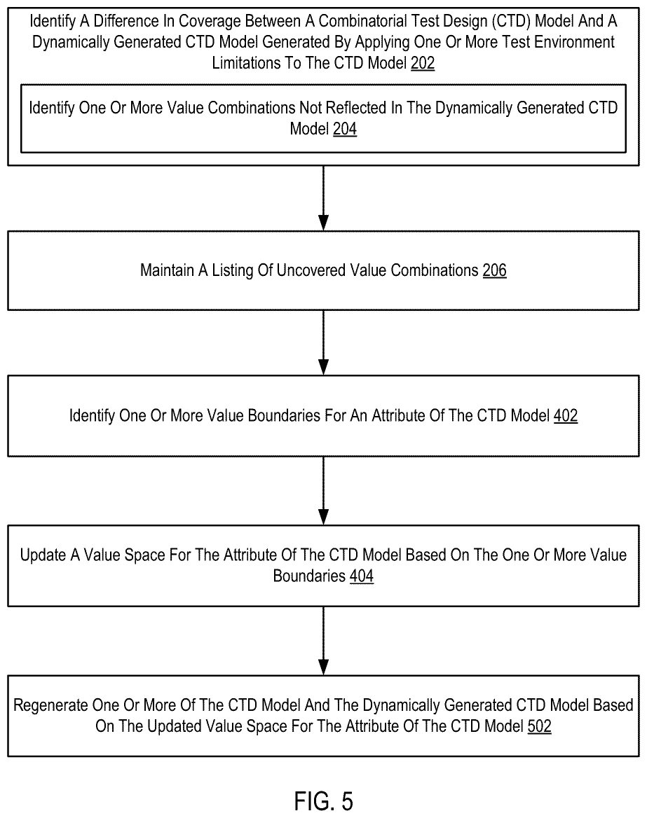

For further explanation, FIG. 5 sets forth a flowchart of another example method of dynamic CTD model tracking and optimization in accordance with some embodiments of the present disclosure. The method of FIG. 5 is similar to FIG. 4 in that the method of FIG. 5 also includes: identifying 202 a difference in coverage between a CTD model and a dynamically generated CTD model generated by applying one or more test environment limitations to the CTD model, including: identifying 204 one or more value combinations not reflected in the dynamically generated CTD model; maintaining 206 a listing of uncovered value combinations; identifying 402 one or more value boundaries for an attribute of the CTD model; and updating 404 a value space for the attribute of the CTD model based on the one or more value boundaries.

The method of FIG. 5 differs from FIG. 4 in that the method of FIG. 5 includes regenerating 502 one or more of the CTD model and the dynamically generated CTD model based on the updated value space for the attribute of the CTD model. As the value space for a particular attribute has been tested, the CTD model should be regenerated such that the n-wise reduction for the CTD space includes the added values based on the identified boundary conditions. Moreover, a dynamically generated CTD model should be regenerated to similarly reflect the updated value space for the attribute.

Testing edge cases, including boundary values, may be particularly valuable when creating a test space. By updating the CTD model and the dynamically generated CTD model using an updated value space to include values based on identified boundaries, this optimizes and improves the overall quality of the generated test cases and test coverage. After regenerating 502 one or more of the CTD model and the dynamically generated CTD model based on the updated value space for the attribute of the CTD model, the methods described above may be performed using the updated CTD model and dynamically generated CTD model in order to monitor which value combinations have not been covered.

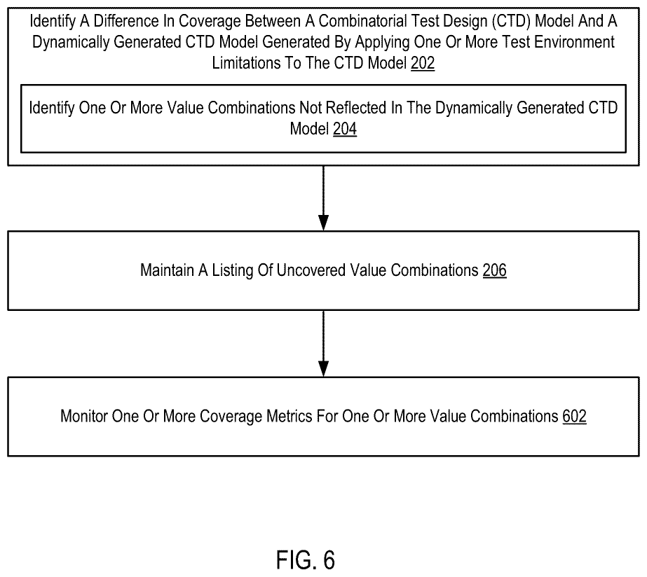

For further explanation, FIG. 6 sets forth a flowchart of another example method of dynamic CTD model tracking and optimization in accordance with some embodiments of the present disclosure. The method of FIG. 6 is similar to FIG. 2 in that the method of FIG. 6 also includes: identifying 202 a difference in coverage between a CTD model and a dynamically generated CTD model generated by applying one or more test environment limitations to the CTD model, including: identifying 204 one or more value combinations not reflected in the dynamically generated CTD model; and maintaining 206 a listing of uncovered value combinations.

The method of FIG. 6 differs from FIG. 2 in that the method of FIG. 6 also includes monitoring 602 one or more coverage metrics for one or more value combinations. The one or more coverage metrics may describe a degree to which the one or more value combinations are included or covered in generated test cases, including in executed and/or unexecuted test cases. For example, the one or more coverage metrics may describe a number of tests that include or cover a particular value combination. As another example, the one or more coverage metrics may describe a percentage of tests that include or cover a particular value combination. Other coverage metrics are also contemplated within the scope of the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
identifying a difference in coverage between a combinatorial test design (CTD) model and a dynamically generated CTD model generated by applying one or more test environment limitations to the CTD model; and
maintaining a listing of uncovered value combinations.

2. The method of claim 1, wherein the CTD model comprises an n-wise reduction of a cartesian product of test value combinations.

3. The method of claim 2, wherein identifying the difference in coverage comprises identifying one or more test cases in the CTD model not included in the dynamically generated CTD model.

4. The method of claim 1, wherein the one or more test environment limitations comprise one or more hardware limitations or one or more software limitations.

5. The method of claim 1, further comprising receiving an update to the dynamically generated CTD model.

6. The method of claim 1, further comprising:
identifying one or more value boundaries for an attribute of the CTD model; and
updating a value space for the attribute of the CTD model based on the one or more value boundaries.

7. The method of claim 6, further comprising regenerating one or more of the CTD model and the dynamically generated CTD model based on the updated value space for the attribute of the CTD model.

8. The method of claim 1, further comprising monitoring one or more coverage metrics for one or more value combinations.

9. An apparatus comprising:
a processing device; and
memory operatively coupled to the processing device, wherein the memory stores computer program instructions that, when executed, cause the processing device to:
identifying a difference in coverage between a combinatorial test design (CTD) model and a dynamically generated CTD model generated by applying one or more test environment limitations to the CTD model; and
maintaining a listing of uncovered value combinations.

10. The apparatus of claim 9, wherein the CTD model comprises an n-wise reduction of a cartesian product of test value combinations.

11. The apparatus of claim 10, wherein identifying the difference in coverage comprises identifying one or more test cases in the CTD model not included in the dynamically generated CTD model.

12. The apparatus of claim 9, wherein the one or more test environment limitations comprise one or more hardware limitations or one or more software limitations.

13. The apparatus of claim 9, wherein the computer program instructions, when executed, further cause the processing device to receive an update to the dynamically generated CTD model.

14. The apparatus of claim 9, wherein the computer program instructions, when executed, further cause the processing device to:
identifying one or more value boundaries for an attribute of the CTD model; and
updating a value space for the attribute of the CTD model based on the one or more value boundaries.

15. The apparatus of claim 14, wherein the computer program instructions, when executed, further cause the processing device to regenerate one or more of the CTD model and the dynamically generated CTD model based on the updated value space for the attribute of the CTD model.

16. A computer program product comprising a computer readable storage medium, wherein the computer readable storage medium comprises computer program instructions that, when executed:
identifying a difference in coverage between a combinatorial test design (CTD) model and a dynamically generated CTD model generated by applying one or more test environment limitations to the CTD model; and
maintaining a listing of uncovered value combinations.

17. The computer program product of claim 16, wherein the CTD model comprises an n-wise reduction of a cartesian product of test value combinations.

18. The computer program product of claim 17, wherein identifying the difference in coverage comprises identifying one or more test cases in the CTD model not included in the dynamically generated CTD model.

19. The computer program product of claim 16, wherein the one or more test environment limitations comprise one or more hardware limitations or one or more software limitations.

20. The computer program product of claim 16, wherein the computer program instructions, when executed, receive an update to the dynamically generated CTD model.
